(19) United States
(12) Patent Application Publication
(10) Pub. No.: US 2015/0256773 A1
(43) Pub. Date: Sep. 10, 2015

(54) SOLID-STATE IMAGE SENSOR DEVICE AND METHOD OF ESTIMATING CORRECT EXPOSURE

(71) Applicant: Kabushiki Kaisha Toshiba, Minato-ku (JP)

(72) Inventor: Nobuyoshi TANAKA, Akishima (JP)

(73) Assignee: Kabushiki Kaisha Toshiba, Minato-ku (JP)

(21) Appl. No.: 14/483,270

(22) Filed: Sep. 11, 2014

Related U.S. Application Data
(60) Provisional application No. 61/949,582, filed on Mar. 7, 2014.

(51) Int. Cl. H04N 5/353; H04N 5/235

(52) U.S. Cl. CPC H04N 5/3537; H04N 5/2353; H04N 5/2351

(57) ABSTRACT

In an embodiment, a sensor unit has a pixel region portion including a plurality of pixels two-dimensionally disposed in rows and columns, a timing generator configured to control exposure times for the plurality of rows so that the exposure times for the pixels are varied with respect to the rows, a comparator configured to make a comparison between a reference value and an integrated value of pixel data on each row on which the exposure times are controlled, and a register configured to hold exposure time information on the row at a match point at which a match occurs between the integrated value and the reference value as a result of the comparison.

### FIELD

Embodiments described herein relate generally to a solid-state image sensor device and a method of estimating a correct exposure.

### BACKGROUND

Solid-state image sensor devices are incorporated in various devices such as digital cameras and smartphones and are being used for shooting photographs. Since shooting is performed in various environments differing in brightness, digital cameras or the like have an automatic exposure function for automatically attaining a correct exposure.

Automatic exposure is performed at the time of shooting. However, factors for correct exposure including the shutter speed are unknown before automatic exposure is performed, for example, immediately after power-on of a digital camera. It is not known whether the power supply of the digital camera is turned on in a dark environment or in a bright environment.

A digital camera or the like is therefore provided with a function to determine a first correct exposure before the automatic exposure function is performed. For example, the function to determine a first correct exposure is a process in which a plurality of images are obtained with a solid-state image sensor device while the shutter speed is gradually changed from an initial value set in advance, and a shutter speed value for a correct exposure is searched for and determined by evaluating the brightness of each image obtained.

In an extremely dark room environment, however, in which the illuminance is, for example, 10 lux or less, the difference between the initial value of the shutter speed set in advance and the shutter speed for a correct exposure in the dark room environment is extremely large. In such a case, the luminance value of image data is so small that it is difficult to estimate the brightness of images. Therefore, a larger amount of image data is needed and a time period taken to determine a first correct exposure is longer than a time period taken to determine a first correct exposure in an environment closer to the initial value set in advance.

Similarly, in an extremely bright environment, such as an environment under the blazing sun, in which the illuminance is 100,000 lux or higher, it is difficult to estimate the brightness of images since the luminance value of image data is saturated. Also in this case, a larger amount of image data is needed and a time period taken to determine a first correct exposure is longer than a time period taken to determine a first correct exposure in an environment closer to the initial value set in advance.

If the exposures for images obtained with the solid-state image sensor device are not substantially correct, the automatic focusing function or the like cannot be performed. Therefore, if the time taken to determine a first correct exposure is increased, the time period from a moment at which a user starts the shooting process to a moment at which it becomes actually possible to shoot is increased.

### BRIEF DESCRIPTION OF THE DRAWINGS

FIG. 1 is a block diagram showing the configuration of a smartphone 1 according to a first embodiment;

FIG. 2 is a block diagram for explaining the configuration of a sensor unit 2 according to the first embodiment;

FIG. 3 is a time chart showing exposure time for each line in a pixel region portion 11 according to the first embodiment;

FIG. 4 is a time chart showing exposure time for each line in the pixel region portion 11 according to the first embodiment in a case where timing of reset is varied from line to line;

FIG. 5 is a time chart showing exposure time and gain for each line in a pixel region portion 11 according to a second embodiment; and

FIG. 6 is a time chart showing exposure time and gain for each line in a pixel region portion 11 according to a third embodiment.

### DETAILED DESCRIPTION

A solid-state image sensor device according to an embodiment includes a pixel region portion including a plurality of pixels two-dimensionally disposed in rows and columns, a timing generator configured to control exposure times for the plurality of rows so that the exposure times for the pixels are varied with respect to the rows, a comparator configured to make a comparison between a reference value and an integrated value or an average value of pixel data on each row or a predetermined number of rows on which the exposure times are controlled, and a holding section configured to hold exposure time information on the row at a match point at which a match occurs between the integrated value or the average value and the reference value or a point of change of a magnitude relationship therebetween as a result of the comparison.

A solid-state image sensor device according to an embodiment includes a pixel region portion including a plurality of pixels two-dimensionally disposed in rows and columns, a gain control unit configured to control gains for the plurality of rows so that the gains are varied with respect to the rows, while exposure times for the pixels are constant, a comparator configured to make a comparison between a reference value and an integrated value or an average value of pixel data on each row or a predetermined number of rows on which the gains are controlled, and a holding section configured to hold exposure time information on the row at a match point at which a match occurs between the integrated value or the average value and the reference value or a point of change of a magnitude relationship therebetween as a result of the comparison.

A method of estimating a correct exposure according an embodiment includes controlling, in a pixel region portion including a plurality of pixels two-dimensionally disposed in rows and columns, exposure times for the plurality of rows so that the exposure times for the pixels are varied with respect to the rows, making a comparison between a reference value and an integrated value or an average value of pixel data on each row or a predetermined number of rows on which the exposure times are controlled, and holding exposure time information on the row at which a match occurs with the reference value or exposure time information on the row corresponding to a point of change of a magnitude relationship with the reference value as a result of the comparison.

A method of estimating a correct exposure according an embodiment includes controlling, in a pixel region portion including a plurality of pixels two-dimensionally disposed in rows and columns, gains for the plurality of rows so that the gains are varied with respect to the rows, while exposure times for the pixels are constant, making a comparison between a reference value and an integrated value or an average value of pixel data on each row or a predetermined number of rows on which the gains are controlled, and holding exposure time information on the row at a match point at which a match occurs between the integrated value or the average value and the reference value or a point of change of a magnitude relationship therebetween as a result of the comparison.

### First Embodiment

### Configuration

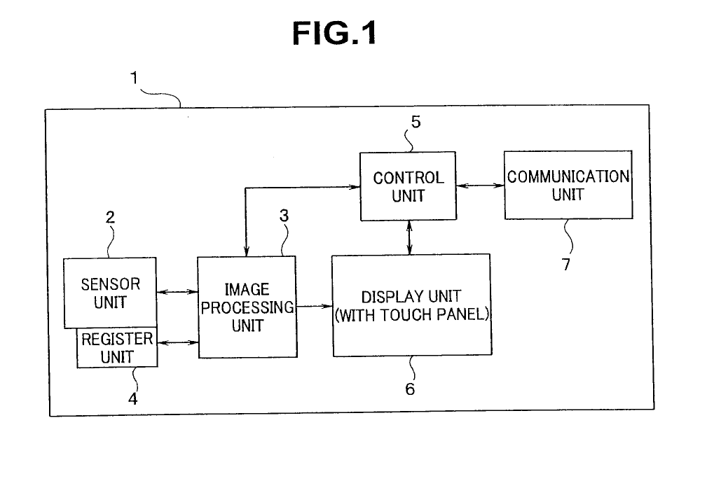

FIG. 1 is a block diagram showing the configuration of a smartphone 1 according to a first embodiment. The smartphone 1 is a shooting device having a camera function and capable of shooting when the camera function is turned on. The smartphone 1 therefore includes a sensor unit 2 for shooting, an image processing unit 3, a register unit 4, a control unit 5, a display unit 6 and a communication unit 7. The sensor unit 2, the register unit 4 and the image processing unit 3 are included in a solid-state image sensor device. Note that each unit of the solid-state image sensor device may be included in one semiconductor device or may be separately provided in two or more semiconductor devices.

Description will now be made mainly with respect to components relating to a shooting function using the solid-state image sensor device in the smartphone 1. No substantial description will be made of components relating to other functions.

The sensor unit 2 is a solid-state image sensor device including an image sensor, e.g., a CMOS image sensor. The image pickup device is driven by a drive signal from the image processing unit 3. Image data obtained by the image sensor is outputted to the image processing unit 3.

The image processing unit 3 performs various kinds of image processing on the image data outputted from the sensor unit 2 and outputs an image signal to the display unit 6. The image processing unit 3 includes an automatic exposure algorithm and outputs to the sensor unit 2 exposure control parameter data for controlling the exposure time at the time of shooting based on the brightness of an image calculated from the image data so that a correct exposure is obtained for a shot image.

The register unit 4 is a storage unit including a plurality of registers in which various sorts of parameter data necessary for the operation of the sensor unit 2 are stored. The sensor unit 2 performs image capturing based on the sorts of parameter data stored in the register unit 4.

The control unit 5 includes a central processing unit (CPU), a ROM and a RAM and performs the overall operation of the smartphone 1.

The display unit 6 is formed of a liquid crystal display and a touch panel. The display unit 6 receives an image signal from the control unit 5 and an image signal from the image processing unit 3 and displays an image on the screen of the liquid crystal display. The display unit 6 outputs to the control unit 5 a command designated by a user touching the screen surface.

The communication unit 7 is a circuit configured to perform communication processing and data communication processing in the smartphone 1 by communicating with a wireless base station.

The user can cause execution of each of various functions of the smartphone 1 by touching the display unit 6, selecting a command according to his/her need and providing a direction to execute the command. The various functions include the shooting function and the user can shoot with the smartphone 1.

When the shooting function is turned on, the sensor unit 2 and the image processing unit 3 are activated. The sensor unit 2 estimates a first correct exposure (hereinafter referred to as “initial correct exposure”) and sends information on the initial correct exposure to the image processing unit 3, as described below. The image processing unit 3 receives the information on the initial correct exposure, then generates parameter data with which a correct exposure can be attained for an image obtained by shooting through the sensor unit 2, and drives the sensor unit 2. The predetermined automatic exposure algorithm thereafter determines a correct exposure based on the brightness of an image obtained by the sensor unit 2, and controls the sensor unit 2.

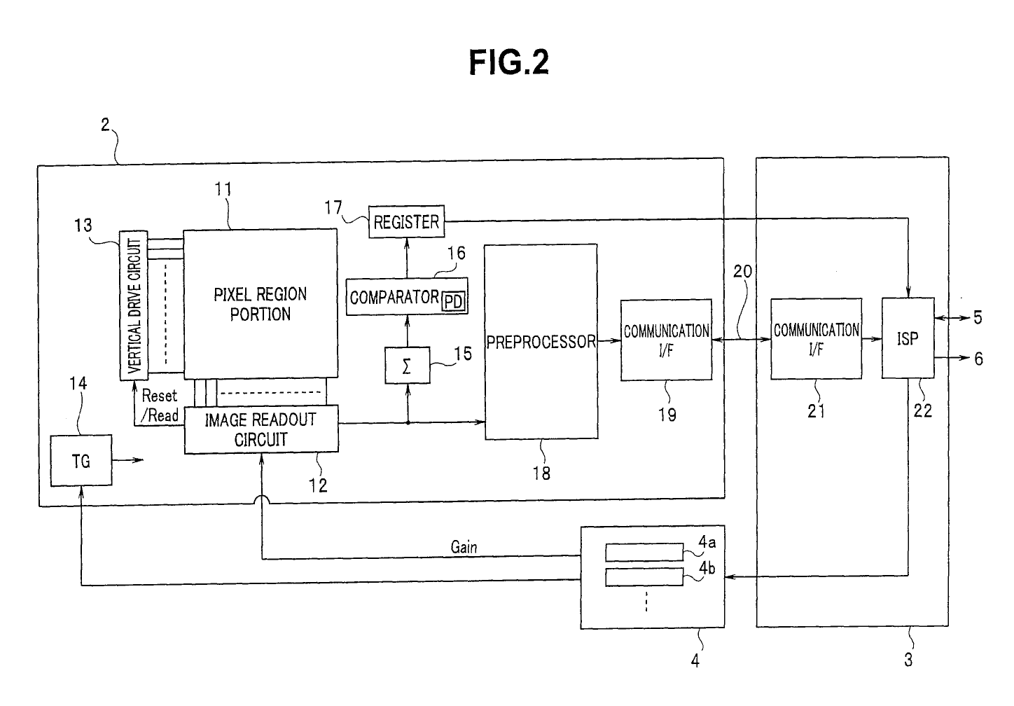

FIG. 2 is a block diagram for explaining the configuration of the sensor unit 2. As shown in FIG. 2, the sensor unit 2 includes a pixel region portion 11, an image readout circuit 12, a vertical drive circuit 13, a timing generator (hereinafter abbreviated as “TG”) 14, an integration circuit (I) 15, a comparator 16, a register 17, a preprocessor 18, and a communication interface (hereinafter abbreviated as “communication I/F”) 19.

The image processing unit 3 includes a communication I/F 21 and an image signal processor (hereinafter referred to as “ISP”) 22.

The register unit 4 includes a plurality of registers in which various sorts of parameter data are set by the image processing unit 3. In a register 4a in the plurality of registers, exposure time data corresponding to the shutter speed is stored. In a register 4b in the plurality of registers, gain data is stored.

The pixel region portion 11 of the solid-state image sensor device includes a plurality of lines in a row direction formed by a plurality of pixels two-dimensionally disposed in rows and columns (in matrix form). The pixel region portion 11 receives light from a subject through an optical system not illustrated, and outputs, on a line-by-line basis, i.e., a row-by-row basis, voltages corresponding to charges respectively accumulated in the pixels. The voltage corresponding to each pixel is amplified at a set gain and outputted. The value of the gain is set in the register 4b.

The image readout circuit 12 includes a correlative double sampling (CDS) circuit for removing a noise component from the voltage for each pixel outputted from the pixel region and an analog-to-digital conversion (ADC) circuit. The image readout circuit 12 outputs digital RAW data after removal of noise components. Timing of readout by the correlative double sampling (CDS) circuit and timing of conversion by the analog-to-digital conversion (ADC) circuit are controlled by the TG 14.

The image readout circuit 12 is supplied with gain data from the register unit 4 and amplifies image data outputted from the pixel region portion 11.

The vertical drive circuit 13 is a circuit that drives the pixel region portion 11 on a line-by-line basis along a vertical direction. The vertical drive circuit 13 drives the pixel region portion 11 on a line-by-line basis by resetting charge on each pixel by specified timing such that charge accumulated on each pixel is transferred after exposure for a specified time period. That is, the amount of exposure of pixels in each line in the pixel region portion 11 is controlled on a line-by-line basis and charges on the plurality of pixels are read along the vertical direction on a line-by-line basis and outputted to the image readout circuit 12.

The TG 14 generates various timing signals for causing each circuit in the sensor unit 2 to operate by timing set by information supplied from the register unit 4, and outputs the timing signals to the circuits in the sensor unit 2. The timing signals generated in the TG 14 include signals for timing of reset and read of each line by the vertical drive circuit 13, timing of correlative double sampling and analog-to-digital conversion by the image readout circuit 12 and signals for the integration circuit 15 and the comparator 16. The TG 14 also controls the exposure times with respect to the plurality of lines so that the exposure times are varied from line to line, as described below.

The integration circuit 15 is a circuit configured to calculate an integrated value of pixel data items for each line. That is, the integration circuit 15 is supplied with the pixel values of the plurality of pixels in one line, calculates the sum of the pixel values of the pixels in one line, and outputs the calculated sum as an integrated value.

The comparator 16 is a circuit configured to compare a reference value PD set in advance and the integrated value from the integration circuit 15 and, when a match occurs between the integrated value and the reference value PD, output to the register 17 information indicating the line at which the match has occurred (hereinafter referred to as “line information”). The comparator 16 holds a count value in correspondence with the time at which the integrated value is inputted thereto, and outputs the count value as line information to the register 17 when there is a match between the integrated value and the reference value PD. For example, the line information indicates the line number when there is a match between the integrated value and the reference value PD.

Note that the comparator 16 may output exposure time data when there is a match between the integrated value and the reference value PD to the register 17. In such a case, since the exposure time data is stored in the register 4a, the exposure time data in the register 4a is transferred to the register 17 based on a match signal from the comparator 16.

The effect in the present embodiment can also be achieved by obtaining in the comparator 16 information indicating the line recognized as a change point at which the magnitude relationship between the integrated value and the reference value PD is reversed as well as the occurrence of a match between the integrated value and the reference value PD. In the description made below, a match between the integrated value or an average value and the reference value PD is assumed to include a point of change of the magnitude relationship between the integrated value or the average value and the reference value PD.

As described above, the comparator 16 makes a comparison between the integrated value of pixel data on each line on which exposure times are controlled and the reference value PD.

The reference value PD held by the comparator 16 is a value corresponding to the standard reflectance in the present embodiment. The standard reflectance is a reflectance of 18%. At this reflectance, a correct exposure is obtained. In the present embodiment, therefore, a value corresponding to the standard reflectance is set as reference value PD and it is inferred that the line at which a match occurs between the integrated value and the reference value PD is the line having undergone exposure with the shutter speed with which the correct exposure can be attained.

Note that while the reference value PD is assumed to be the standard reflectance in the present embodiment, the reference value PD may be a value other than the standard reflectance, e.g., a value corresponding to a reflectance of 20%.

In the register 17, line information from the comparator 16 is stored, as described above. Accordingly, the register 17 is a holding section that holds, as match information indicating that a match has occurred between the integrated value and the reference value PD as a result of comparison in the comparator 16, line information indicating the line at which a match has occurred between the integrated value and the reference value PD.

The preprocessor 18 is supplied with RAW data from the image readout circuit 12, and performs image processing including shading processing and noise correction on the RAW data. The preprocessor 18 outputs to the communication I/F 19 the RAW data processed by the image processing.

The communication I/F 19 is a circuit for transmitting RAW data in a predetermined data format. The communication I/F 19 is connected to the communication I/F 21 in the image processing unit 3 by a signal line 20. RAW data is inputted to the ISP 22 through the communication I/F 21. The ISP 22 performs various kinds of image processing including optical correction and defect correction on the RAW data and outputs the processed RAW data to the control unit 5 and the display unit 6.

The ISP 22 has an automatic exposure function for attaining a correct exposure at the time of shooting, generates various sorts of parameter data for controlling, for example, the shutter speed, i.e., the exposure time in the sensor unit 2 based on image data, and writes the parameter data to the group of registers in the register unit 4.

The ISP 22 generates exposure time data relating to the shutter speed and gain data for amplification of the pixel value as control parameters for exposure control in the sensor unit 2. The ISP 22 writes the exposure time data to the register 4a and writes the gain data to the register 4b.

Further, the ISP 22 also writes to other registers in the register unit 4 various timing data items, for example, for correlative double sampling, analog-to-digital conversion, the integration circuit 15 and the comparator 16, as described above.

When automatic exposure is being performed, the ISP 22 generates parameter data for controlling the shutter speed and the gain by the automatic exposure algorithm at the time of shooting based on the brightness of an image calculated from image data so that a correct exposure is obtained for a shot image, and outputs the parameter data to the register unit 4.

Further, the ISP 22 also executes process for estimating an initial correct exposure before automatic exposure is performed. More specifically, before the automatic exposure algorithm is executed, the ISP 22 executes initial correct exposure estimation processing described below, reads out from the register 17 line information obtained by the initial correct exposure estimation processing, and determines first exposure control parameters at the time of execution of the automatic exposure algorithm.

### (Operation)

Initial correct exposure estimation processing before automatic exposure is performed will be described.

In the present embodiment, the exposure time for each line is controlled to estimate an initial correct exposure. To perform this control, the ISP 22 writes parameter data for control of the timing signal for reset and read of each line by the vertical drive circuit 13, i.e., exposure time data, to the register 4a. Timing of read of each line is controlled based on the exposure time data written to the register 4a.

When initial correct exposure estimation processing is performed, integrated values of pixel data on the lines are successively inputted to the comparator 16. From the comparator 16, line information when a match occurs between one of the inputted integrated values for the plurality of lines and the reference value PD is outputted and written to the register 17. Note that exposure time data on the line at which a match has occurred between the integrated value and the reference value PD may be stored in the register 17, as described above.

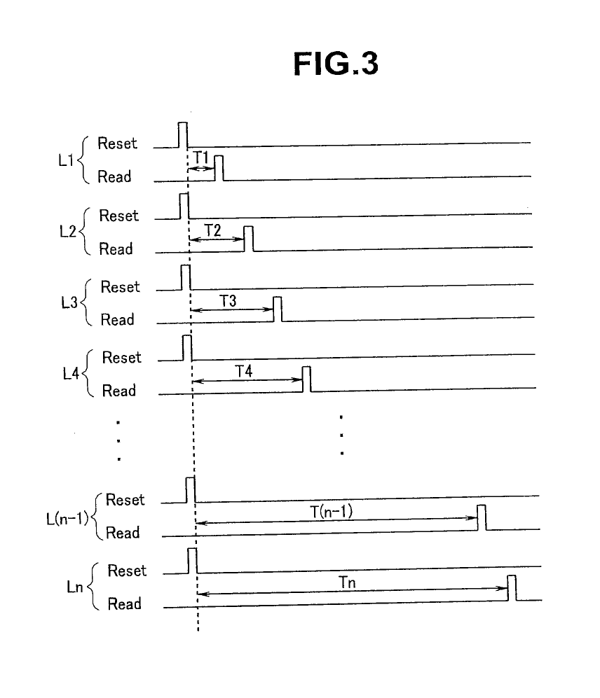

FIG. 3 is a time chart showing the exposure time for each line in the pixel region portion 11. The pixel region portion 11 includes a plurality of pixels forming lines in n rows (n: an integer). In the present embodiment, an initial correct exposure can be estimated by obtaining one image frame.

The ISP 22 controls the exposure times for the plurality of lines in the pixel region portion 11, i.e., timing of read, so that the exposure times for the plurality of lines differ from each other. The ISP 22 writes exposure time data, i.e., timing data for read, to the register 4a in the register unit 4 on a line-by-line basis to control timing of read of each line. In this example of the processing, all the lines are reset by the same timing.

When the first line indicated by L1 is driven, the TG 14 controls exposure time data, i.e., timing data for read after resetting, so that the exposure time is T1. When the second line indicated by L2 is driven, the TG 14 controls exposure time data so that the exposure time is T2. For the other subsequent lines, the exposure time is controlled so as to increase with the increase of the line number.

As a result, the exposure time T1 for the first line is the shortest of the exposure times for all the lines, and the exposure time Tn for the nth line is the longest of the exposure times for all the lines. Read of all the lines is executed, for example, in 1/30 second.

Since one of the lines at which a match occurs between the integrated value from the integration circuit 15 and the reference value PD is the line exposed with a shutter speed with which a correct exposure can be obtained, the shutter speed corresponding to the exposure time for the line is estimated as the shutter speed for an initial correct exposure. The line exposed with the shutter speed for the initial correct exposure is identified from the line information written to the register 17.

The ISP 22 therefore controls the initial exposure time in the sensor unit 2 based on the line information written to the register 17, thereby obtaining a first image for automatic exposure control. More specifically, the ISP 22 writes exposure time data to the register 4a so that the pixel region portion 11 is exposed for the same time period as the exposure time for the line indicated by the line information. For example, if the line information indicating the fourth line indicated by L4 has been written to the register 17, the ISP 22 writes exposure time data to the register 4a so that all the pixels in the pixel region portion 11 are exposed for the exposure time T4 for the fourth line.

The ISP 22 thereafter executes the automatic exposure algorithm. With the automatic exposure algorithm, exposure control on the sensor unit 2 is performed by using as an initial value the exposure time data written to the register 4a. The automatic exposure algorithm is thereafter executed. Exposure time data thereafter written to the register 4a is determined by the automatic exposure algorithm.

As described above, an initial correct exposure parameter can be estimated by only obtaining one image frame. In the conventional art, a plurality of images are obtained and a correct exposure is searched for step by step based on the brightnesses of the plurality of images obtained, so that the time taken to estimate an initial correct exposure parameter is long. In contrast, in the present embodiment, an initial correct exposure parameter can be estimated from only one image frame and, therefore, the time taken to estimate an initial correct exposure parameter is reduced in comparison with the conventional art.

The time period from turning on of the shooting function to the completion of estimation of an initial exposure parameter is thus reduced. As a result, the time period from a moment at which a user starts the shooting process to a moment at which it becomes actually possible to shoot is reduced.

Note that in the above-described example, all the lines are reset by the same timing, and timing of read is changed. However, timing of reset may be varied from line to line. That is, the TG 14 may change timing of reset and timing of read among the lines.

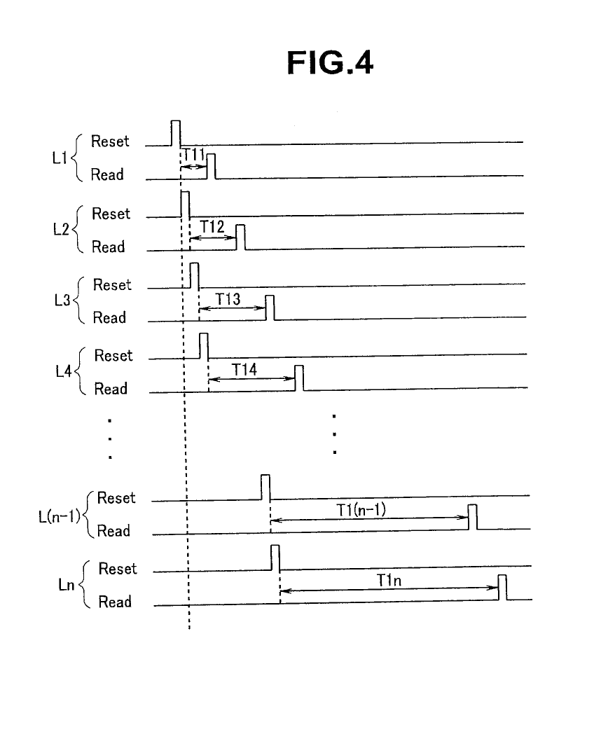

FIG. 4 is a time chart showing the exposure time for each line in the pixel region portion 11 in a case where timing of reset is varied from line to line.

As shown in FIG. 4, timing of reset is controlled so as to be shifted and delayed relative to reset timing on the first line with the increase of the line number. Data on timing of rest of each line is written to another register in the register unit 4 to enable control of timing of reset of each line.

Also in the case shown in FIG. 4, the exposure time T11 for the first line is the shortest of the exposure times for all the lines, and the exposure time T1n for the nth line is the longest of the exposure times for all the lines.

Not only timing of read of each line but also timing of reset may be varied from line to line, as shown in FIG. 4.

### Second Embodiment

In the first embodiment, the exposure times are controlled so as to be varied from line to line at the time of initial correct exposure estimation processing. In the second embodiment, not only the exposure times but also the gains are controlled so as to be varied among part of the lines at the time of initial correct exposure estimation processing.

The hardware configuration of a smartphone in the present embodiment is the same as that of the smartphone 1 in the first embodiment shown in FIGS. 1 and 2. Therefore, the same components are indicated by using the same reference characters and the descriptions for them will not be repeated. Description will be made of points of difference in configuration and operation from the first embodiment.

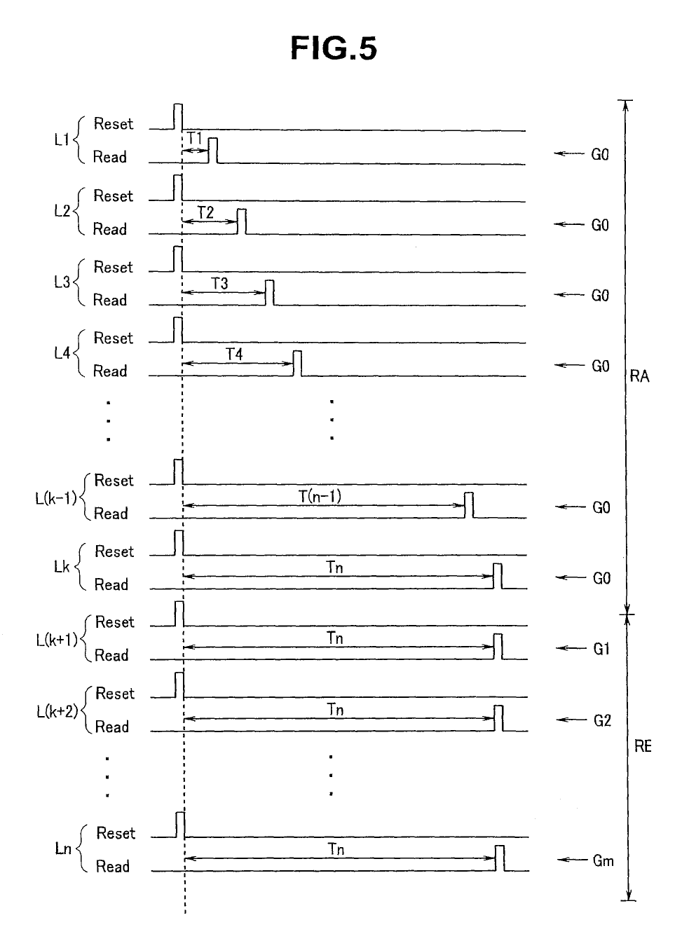

FIG. 5 is a time chart showing the exposure time and the gain for each line in the pixel region portion 11. The ISP 22 controls timing of read of a plurality of lines in a region RA from the first line to the kth line in the plurality of lines in the pixel region portion 11 so that the exposure times are varied from line to line. Further, the ISP 22 controls the gains for a plurality of lines in a region RB from the (k+1)th line to the nth line in the plurality of lines in the pixel region portion 11 so that the gains are varied from line to line, while the exposure times are constant.

Also in the present embodiment, data on timing of read is controlled on a line-by-line basis in the region RA by means of the register 4a in the register unit 4 for control of timing of read of each line. In the region RA, the gain and timing of reset are constant with respect to all the lines.

In the region RB, while timings of read of each line are fixed, the gains are varied from line to line.

That is, in the region RA, control is performed so that timings of read, i.e., the exposure times, are varied from line to line, while the gains are constant among the lines.

In the region RB, control is performed so that timing of read, i.e., the exposure time, is constant among the lines, while the gains are varied from line to line.

In the example shown in FIG. 5, the value of the gain in the region RA is G0, which is constant, while in the region RB the exposure times are constant and the value of the gain is changed so as to increase from G1 to Gm. Accordingly, the ISP 22 and the register 4b form a gain control unit that controls the gains for the plurality of lines so that the gains are varied from line to line in the region RB.

In a case where, as in the present embodiment, the gains are changed in the region RB so that gain data is gradually increased while a shutter speed condition is set such that the exposure time for each line is maximized, a shutter speed and a gain with which a correct exposure for an image is attained can be estimated by only obtaining one image frame even in a dark environment in which a correct exposure cannot be obtained when only adjustment of the shutter speed is performed.

Note that also in the present embodiment, timing of reset may be varied from line to line, as shown in FIG. 4 with respect to the first embodiment.

### Third Embodiment

In the first embodiment described above, an initial correct exposure parameter is estimated by varying only the shutter speed from line to line in one frame. In the second embodiment, the shutter speed is changed in one frame and an initial correct exposure parameter is thereafter estimated by increasing the gain while fixing the shutter speed at the lowest speed. In contrast, in the third embodiment, an initial correct exposure parameter is estimated by varying only the gain from line to line in one frame.

When shooting with the smartphone 1 is performed in a dark place such as the interior of a room, or when shooting is performed in an operation mode such that the shooting operation is performed only with a predetermined high shutter speed, the range of change of the shutter speed is restricted or the shutter speed is fixed.

In the present embodiment, an initial correct exposure parameter is estimated by changing only the gain in one image frame in a particular shooting mode, such as an indoor shooting mode or a high-speed shutter mode, in which the range of change of the shutter speed is restricted or the shutter speed is fixed.

The hardware configuration of the smartphone in the present embodiment is the same as that of the smartphones 1 in the first and second embodiments shown in FIGS. 1 and 2. Therefore, the same components are indicated by using the same reference characters and the descriptions for them will not be repeated. Description will be made of points of difference in configuration and operation from the first embodiment.

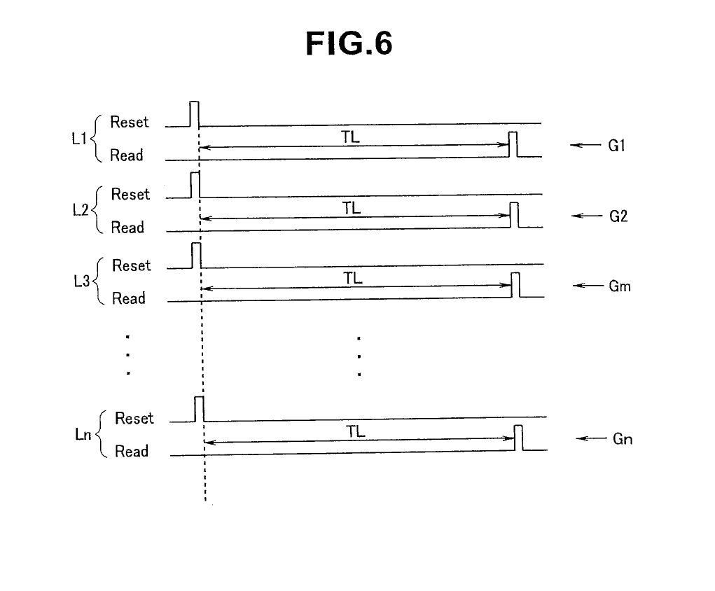

FIG. 6 is a time chart showing the exposure time and the gain for each line in the pixel region portion 11. The ISP 22 controls timing of read of a plurality of lines so that the exposure times for the first to the nth lines in the plurality of lines in the pixel region portion 11 are equal to one time period TL. Further, the ISP 22 controls the gains for the plurality of lines so that the gains are varied from line to line from the first to nth lines in the plurality of lines in the pixel region portion 11.

Also in the present embodiment, the ISP 22 controls timing of read of each line by writing exposure time data to the register 4a in the register unit 4. Exposure time data items respectively set for all the lines are identical to each other. Also, the ISP 22 controls the gain by writing gain data to the register 4b in the register unit 4 on a line-by-line basis.

That is, the ISP 22 writes exposure time data to the register 4a so that timing of read is fixed among the lines, and writes gain data to the register 4b so that the gain is varied from line to line. Accordingly, the ISP 22 and the register 4b form a gain control unit that controls the gains for the plurality of lines so that the gains are varied from line to line.

Referring to FIG. 6, the value of the gain is changed so as to increase from G1 to Gn with respect to the first line to the nth line indicated by L1 to Ln.

An initial correct exposure parameter is estimated by changing only the gains in one frame while the exposure times are fixed, as in the present embodiment. Therefore, a gain or a shutter speed and a gain with which a correct exposure for an image is attained can be estimated by only obtaining one image frame even in a mode in which shooting is performed by limiting the shutter speed within a predetermined range of change or fixing the shutter speed at a set value.

Note that also in the present embodiment, timing of reset may be varied from line to line, as shown in FIG. 4 with respect to the first embodiment.

Modifications of the above-described three embodiments will be described.

### Modification 1

In each of the above-described embodiments, initial correct exposure estimation processing is executed when the shooting function of the smartphone 1 is turned on. Initial correct exposure estimation processing, however, may be executed when shooting of one frame is completed and when next shooting is enabled.

When one image frame is shot, the shot image is displayed on the display unit 6. When next shooting is enabled after this display, a live image is again displayed on the display unit 6. That is, the operation of the sensor unit 2 is stopped during the time period from a moment at which shooting of one frame is completed to a moment at which display of the next live image is started. When the shooting function of the sensor unit 2 is resumed after such a temporary suspension, the initial correct exposure estimation processing in any one of the above-described embodiments may be executed.

### Modification 2

In each of the above-described embodiments, integrated values of pixel data are calculated in the integration circuit 15 and compared with the reference value PD in the comparator 16 with respect to all the lines in the pixel region portion 11. However, integration and comparison are not necessarily performed with respect to all the lines in the pixel region portion 11. For example, integration and comparison may be performed with respect to a plurality of lines selected at certain intervals, e.g., every second or every third lines.

### Modification 3

In each of the above-described embodiments, only the shutter speed, the shutter speed and the gain or only the gains are changed in one image frame. However, only the shutter speed, the shutter speed and the gain or only the gain may be changed through two or more image frames.

The ISP 22 and the register 4b as a gain control unit may control the gains so that the gains are varied from line to line in data on two or more image frames instead of controlling the gains so that the gains are varied from line to line in data on one image frame.

For example, if the operation according to one of the first to third embodiments is performed on two image frames, estimation of the exposure time and the gain for a two times finer and more correct initial correct exposure can be made.

### Modification 4

In each of the above-described embodiments, the exposure time and the gain are changed so that the exposure time becomes longer and the gain becomes higher with the advance of read of the lines in the pixel region portion 11. However, the exposure time and the gain may alternatively be changed so that the exposure time becomes shorter and the gain becomes lower with the advance of read of the lines in the pixel region portion 11.

### Modification 5

In each of the above-described embodiments, initial correct exposure estimation processing is controlled by the ISP 22. Initial correct exposure estimation processing, however, may be executed independently of the ISP 22.

For example, a control section for initial correct exposure estimation processing may be provided in the sensor unit 2 to execute initial correct exposure estimation processing.

### Modification 6

In each of the above-described embodiments, integrated values of pixel data are calculated in the integration circuit 15 and compared with the reference value PD in the comparator 16. However, an average value of pixel data on each line may be used in place of the integrated value. In such a case, the reference value PD is a value corresponding to the average value.

### Modification 7

While in each of the above-described embodiments integrated values of pixel data are calculated in the integration circuit 15 and compared with the reference value PD in the comparator 16, an integrated value or a moving average of average values of pixel data on a plurality of lines adjacent one to another may be used in place of the integrated value of each line. In such a case, the reference value PD is a value corresponding to the moving average.

### Modification 8

While each of the above-described embodiments is an independent embodiment, the three embodiments may be combined.

For example, when the smartphone 1 enters the shooting mode, the ISP 22 first may execute the initial correct exposure estimation processing in the first embodiment and execute the initial correct exposure estimation processing in the second embodiment if the comparator 16 outputs no match signal in the initial correct exposure estimation processing in the first embodiment.

The ISP 22 may alternatively determine and change initial correct exposure estimation processing to be executed according to the shooting mode. For example, the ISP 22 executes the initial correct exposure estimation processing in the first or second embodiment in an ordinary shooting mode and executes the initial correct exposure estimation processing in the third embodiment in a particular shooting mode such as an indoor shooting mode or a high-speed-shutter shooting mode.

### Modification 9

Further, the comparator 16 may write exposure time information to the register 17 and end the initial correct exposure estimation processing when a match occurs between the integrated value, the average value or the moving average and the reference value PD, or when a point of change of the magnitude relationship therebetween is obtained. The adjustment time can be further reduced in this way.

### Modification 10

Further, two or more of the above-described plurality of modifications may be combined and applied to any one of the embodiments.

As described above, each of the above-described embodiments and modifications ensures that the time period from a moment at which the power supply of the smartphone 1 is turned on or the shooting function of the smartphone 1 is turned on to a moment at which a first correct exposure is estimated is reduced and the time period from a moment at which the user starts the shooting process to a moment at which it becomes actually possible to shoot is reduced.

Note that while each of the above-described embodiments and modifications has been described by way of example with respect to a case where a smartphone is used as a shooting device, each of the above-described embodiments and modifications can also be applied to shooting devices such as portable telephones other than the smartphone, digital cameras, digital video cameras, with which digital photographs and moving images are shot.

While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A solid-state image sensor device comprising:
a pixel region portion including a plurality of pixels two-dimensionally disposed in rows and columns;
a timing generator configured to control exposure times for the plurality of rows so that the exposure times for the pixels are varied with respect to the rows;
a comparator configured to make a comparison between a reference value and an integrated value or an average value of pixel data on each row or a predetermined number of rows on which the exposure times are controlled; and
a holding section configured to hold exposure time information on the row at a match point at which a match occurs between the integrated value or the average value and the reference value or a point of change of a magnitude relationship therebetween as a result of the comparison.

2. The solid-state image sensor device according to claim 1, wherein the exposure time information is row information indicting the row at which a match occurs between the integrated value or the average value and the reference value or the magnitude relationship is changed.

3. The solid-state image sensor device according to claim 1, further comprising a gain control unit configured to control gains for the plurality of rows so that the gains are varied with respect to the rows, while the exposure times for the pixels are constant.

4. The solid-state image sensor device according to claim 1, wherein the timing generator controls the exposure times for the pixels by synchronizing timings of reset with respect to the rows and by changing timings of read with respect to the rows.

5. The solid-state image sensor device according to claim 1, wherein the timing generator controls the exposure times by changing timings of reset and timings of read with respect to the rows.

6. The solid-state image sensor device according to claim 1, wherein the integrated value or the average value is a moving average of the integrated value or a moving average of the average value, respectively.

7. The solid-state image sensor device according to claim 1, wherein the timing generator controls the exposure times so that the exposure times for the pixels are varied with respect to the rows in data on one image frame.

8. The solid-state image sensor device according to claim 1, wherein the timing generator controls the exposure times so that the exposure times for the pixels are varied with respect to the rows in data on two or more image frames.

9. A solid-state image sensor device comprising:
a pixel region portion including a plurality of pixels two-dimensionally disposed in rows and columns;
a gain control unit configured to control gains for the plurality of rows so that the gains are varied with respect to the rows, while exposure times for the pixels are constant;
a comparator configured to make a comparison between a reference value and an integrated value or an average value of pixel data on each row or a predetermined number of rows on which the gains are controlled; and
a holding section configured to hold exposure time information on the row at a match point at which a match occurs between the integrated value or the average value and the reference value or a point of change of a magnitude relationship therebetween as a result of the comparison.

10. The solid-state image sensor device according to claim 9, wherein the exposure time information is line information indicting the row at which a match occurs between the integrated value or the average value and the reference value.

11. The solid-state image sensor device according to claim 9, wherein the integrated value or the average value is a moving average of the integrated value or a moving average of the average value, respectively.

12. The solid-state image sensor device according to claim 9, wherein the gain control unit controls the gains so that the gains are varied with respect to the rows in data on one image frame.

13. The solid-state image sensor device according to claim 9, wherein the gain control unit controls the gains so that the gains are varied with respect to the rows in data on two or more image frames.

14. A method of estimating a correct exposure, comprising:
controlling, in a pixel region portion including a plurality of pixels two-dimensionally disposed in rows and columns, exposure times for the plurality of rows so that the exposure times for the pixels are varied with respect to the rows;
making a comparison between a reference value and an integrated value or an average value of pixel data on each row or a predetermined number of rows on which the exposure times are controlled; and
holding exposure time information on the row at which a match occurs with the reference value or exposure time information on the row corresponding to a point of change of a magnitude relationship with the reference value as a result of the comparison.

15. The method of estimating a correct exposure according to claim 14, wherein the exposure time information is line information indicting the row at which a match occurs with the reference value or the magnitude relationship is changed.

16. The method of estimating a correct exposure according to claim 14, further comprising controlling gains for the plurality of rows so that the gains are varied with respect to the rows, while the exposure times for the pixels are constant.

17. The method of estimating a correct exposure according to claim 14, wherein the exposure times for the pixels are controlled by synchronizing timings of reset with respect to the plurality of rows and by changing timings of read with respect to the plurality of rows.

18. The method of estimating a correct exposure according to claim 14, wherein the exposure times for the pixels are controlled by changing timings of reset and timings of read with respect to the plurality of rows.

19. The method of estimating a correct exposure according to claim 14, wherein the integrated value or the average value is a moving average of the integrated value or a moving average of the average value, respectively.

20. The method of estimating a correct exposure according to claim 14, wherein the exposure times for the pixels are controlled so that the exposure times are varied with respect to the rows in data on one image frame.
